(19) United States
(12) Patent Application Publication
(10) Pub. No.: US 2019/0291376 A1
(43) Pub. Date: Sep. 26, 2019

(54) PORTABLE HEATED PRESS

(71) Applicant: Chao Xu, Markham (CA)

(72) Inventor: Chao Xu, Markham (CA)

(21) Appl. No.: 16/363,397

(22) Filed: Mar. 25, 2019

Related U.S. Application Data
(60) Provisional application No. 62/647,306, filed on Mar. 23, 2018.

(51) Int. Cl. B30B 15/34

(52) U.S. Cl. CPC B30B 15/34

(57) ABSTRACT

A portable heated press device is disclosed that has an upper and lower member, each having an electrically heated platen, hingedly attached to one another near the platens. The lever design allows for multiplying the force applied to the member. An insulator ring is used to thermally insulate the heat from the platens from the handles of the device. The device can include a locking mechanism at the end opposite the platens to apply and maintain pressing force at the platens. The device can also be opened to 180 degrees to allow one platen to be used as a hot plate.

### FIELD

The present disclosure relates generally to a portable heated press. More particularly, the disclosure relates to a heated press for extracting plant concentrates.

### BACKGROUND

It is desirable to extract plant concentrates using heat and pressure. To properly extract plant concentrates it is important to use the precise pressure and heat distribution to maximize yield and not to damage the plant concentrate. If too much pressure is applied to the plant, then the quality of the extracted plant concentrate can be negatively affected, such as by including extra plant matter in the extracted plant concentrate.

Heat is necessary to lower the viscosity of the plant concentrate to allow it to flow. Heat can melt certain plant structures that hold the desired plant concentrates and can also reduce the viscosity of the plant concentrate. It is important to apply heat evenly across the pressed plant material to maximize flow and yield of the plant concentrate. Too much heat can denature the plant concentrate which can affect potency.

Hair straighteners are used as an improvised plant concentrate extraction device. The operation involves placing the plant material pre-wrapped in parchment paper (or any other type of non-stick material) in between the two heated platens of the hair straightener, at which point an external force is applied to the hair straightener, near where the plant material has been placed. The heat lowers the viscosity of the essential oils contained within the plant so that once pressure is applied, the desired plant concentrate will readily separate itself from the plant material. The concentrate can then be collected from the parchment paper using a scraping tool.

A hair straightener is not a suitable device for plant concentrate extraction. These devices are not suitable for sustaining high-pressure application due to their fragile design and construction. A hair straightener also requires an external and independent device to provide a precisely controlled pressure. Often hair straighteners have too high an operating temperature which can reduce yield or denature the extracted plant concentrate. Micropac GmbH sells a rosin press under the tradename “Oil Black Leaf' Rosin Press” that is basically an improvised hair straightener design with a temperature control suitable for extracting particular plant rosins. A similar improvised hair straightener design is also sold under the trademark Rortek by AEG Capital Corp.

Another commonly used approach is to mount custom heated platens to a hydraulic press. This approach is not easily portable nor accessible due to its weight and size. Furthermore, the cost of such apparatus is considered prohibitive to casual consumers, and its usage is generally restricted within industrial-sized operations. Midwest Concentrates provides a kit online that includes two temperature-controlled plates and a common hardware store one-handed bar clamp for providing the pressing the force. Although this approach may be slightly more portable, it may not be easy or safe to assemble and use.

None of the prior art approaches disclosed provides a direct and convenient method of utilizing the heat source to further refine the extracted plant concentrate to obtain other desirable compounds. For example, some plant concentrates can be further processed with heat (which is higher than the desired extraction temperature) to alter the plant concentrates chemical structure or bioavailability.

### SUMMARY

According to a first aspect, a portable heated press is provided comprising an upper member having a first pressing head, the first pressing head having a first electrically heated platen; and a lower member having a second pressing head, the second pressing head having a second electrically heated platen, the lower member hingedly coupled to the upper member near the first and second pressing heads. The upper member and lower member can each further comprise an insulator ring attached between the electrically heated platen and the pressing head. The insulator ring having should have a low thermal conductivity and mechanical rigidity. The insulator ring can be comprised of any one of: stainless steel, high temperature resistant plastic, a glass fiber reinforced nylon, a carbon fiber reinforced nylon, and a polyamide-imides thermoplastic.

The upper member and lower member can each have a handle portion opposite their respective pressing heads. A handle insulator can be included between the handle portion and the pressing head on each member. The upper member and lower member can each have a heat dissipater between handle portion and the pressing head that acts a heat sink.

Some aspects of portable heated press can have a tail portion with a locking mechanism. The locking mechanism can be a pressing bolt, a clamp, a racheting system, a buckle, or a latch.

Each pressing head can have an electrical heating element attached to its platen, and can further include a temperature sensor. A heat spreader can be attached between the heating element and the temperature sensor. Some aspects can also incude a controller that is coupled to the temperature sensor and each electrical heating element that receives feedback from the temperature sensor to control the electrical heating element. A thermal safety fuse can also be used to prevent platens from exceeding a safety temperature. The pressing head can have a containment structure to maintain the electrical heating element, the heat spreader, the temperature sensor, and the safety fuse, positioned within pressing head.

Some aspect of portable heated press can allow the lower member and upper member to be opened at a 180-degree angle, and the lower member can have a flat bottom surface to allow it to lay flat to provide one of the platens as a hot plate. The controller can be configured to activate second electrically heated platen of the lower member, and to deactivate first electrically heated platen of the upper member.

According to a second aspect, a kit comprising a portable heated press and a heating pan is provided for extracting and processing plant material, the kit can include the portable heated press capable of the hot plate configuration, and a heating pan sized for the second electrically heated platen.

### BRIEF DESCRIPTION OF THE DRAWINGS

For a better understanding of the various embodiments described herein and to show more clearly how they may be carried into effect, reference will now be made, by way of example only, to the accompanying drawings which show at least one exemplary embodiment, and in which:

FIG. 1 is a perspective view of a portable heated press showing the anchor bolt removed;

FIG. 2 is an exploded view of the pressing heads of the portable heated press of FIG. 1;

FIG. 3 is an exploded view of the portable heated press of FIG. 1;

FIG. 4 is a cross-sectional view of the pressing head of the portable heated press;

FIG. 5 is a top plan view of a controller housing for controlling the portable heated press of FIG. 1;

FIG. 6 is a partial perspective view of the portable heated press of FIG. 1 in a hot plate configuration with the upper member and lower member open at 180 degrees; and

FIG. 7 is a perspective view of a heating pan for use with the portable heated press of FIG. 1.

### DESCRIPTION OF VARIOUS EMBODIMENTS

It will be appreciated that for simplicity and clarity of illustration, where considered appropriate, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementations of various embodiments described herein.

Although some embodiments may explicitly refer to a heated press device for plant material, it will be understood by those of ordinary skill in the art that teachings described herein may be applied to devices for other applications, such as a press for T-shirt iron-on designs, for example.

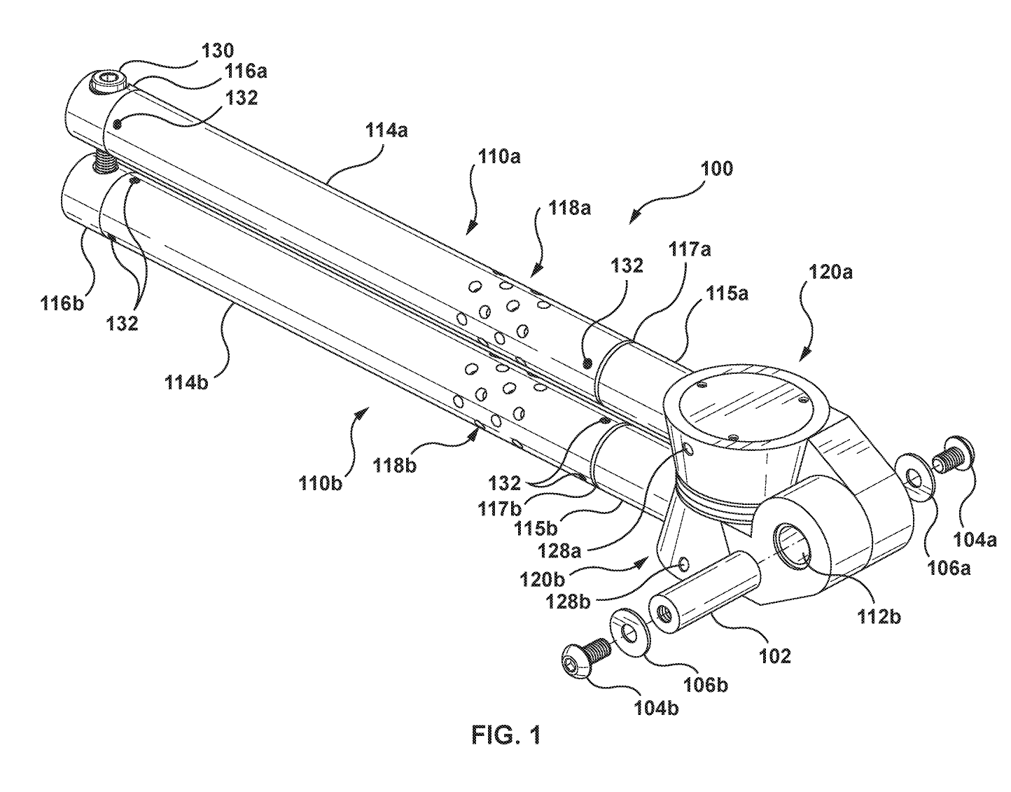

Reference is first made to FIG. 1, shown is a perspective view of a portable heated press 100 having an upper member 110a and a lower member 110b illustrated in the closed position, or pressing position. An anchor bolt 102 couples upper member 110a and lower member 110b to form a fulcrum mechanism. Using a single fulcrum design allows upper member 110a and lower member 110b to have the same shape to allow for more cost-efficient manufacturing of heated press 100. For convenience, sub-parts of upper member 110a have an “a” suffix and sub-parts of lower member 110b have a “b” suffix. In some cases, only aspects of upper member 110a or lower member 110b will be described or aspects will be described without referring to upper member 110a or lower member 110b and the suffix will be omitted.

Other embodiments can have upper member 110a and lower member 110b with differing shapes from one another. For example, upper member 110a and lower member 110b can be joined by a knuckle joint where upper member 110a has a forked end with each having an anchor bore, the forked end spaced to receive the end of lower member 110b therebetween. A knuckle joint can reduce the shear stress forces placed on anchor bolt 102, but this type of design will increase manufacturing costs.

The embodiment illustrated in the drawings provides a class 2 lever arrangement with anchor bore 112a for receiving anchor bolt 102 at one end of upper member 110a nearest pressing head 120a. Preferably, pressing head 120a is located as close to anchor bore 112a to amplify the pressing force from moving upper member 110a and lower member 110b that is applied to pressing heads 120. The lever design allows portable heated press 100 to deliver a pressing force that is multiple times that amount applied at the tail portion of members 110a, 110b to provide industrial grade extraction pressure, while still remaining lightweight and portable.

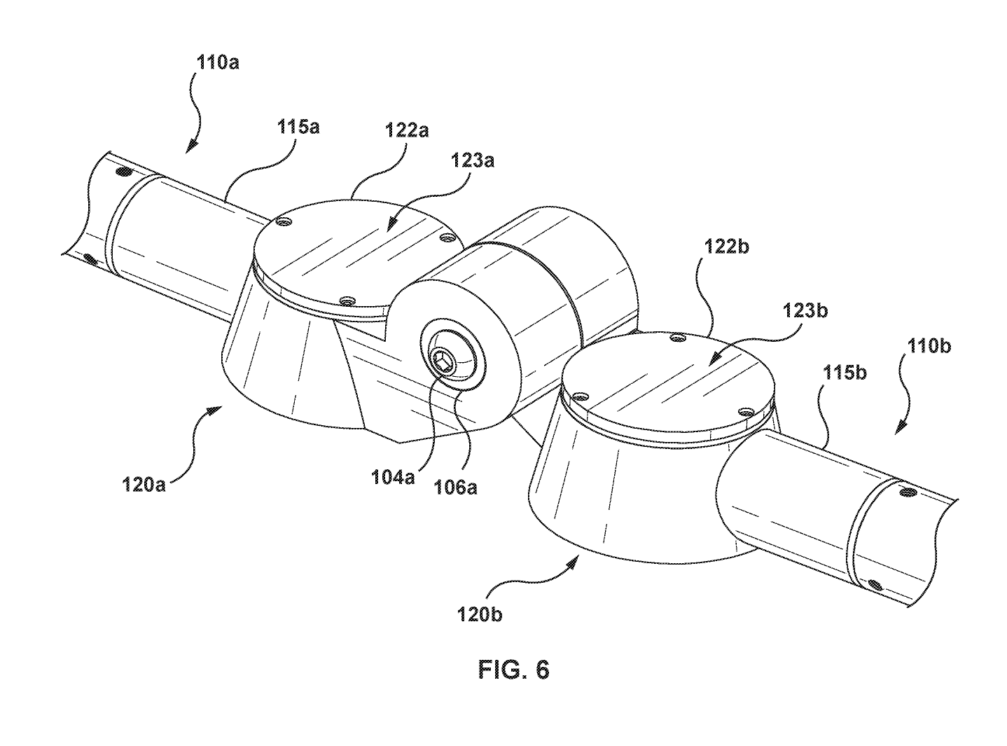

Other embodiments can use a class 1 lever, similar to the fulcrum arrangement with a pair of scissors, where the pressing heads 120 are located at the end of the member 110 and anchor bore 112 is preferably positioned near pressing heads 120 to amplify the pressing force. However, this fulcrum arrangement does not allow the hot plate configuration shown in FIG. 6. Pressing force between pressing heads 120 can also be altered by changing the length of upper member 110a and lower member 110b.

Other embodiments of heated press 100 can have different fulcrum mechanisms. For example, where heated press 100 is used to press material with a larger thickness, upper member 110a and lower member 110b can each hingedly attach to an intermediate member. The intermediate member can allow the pressing surfaces of pressing heads 120 to remain parallel when pressing thicker material.

Anchor bolt 102 can be internally threaded to receive securing bolts 104a, 104b to secure anchor bolt 102 within anchor bores 112a, 112b to hingedly attach upper member 110a to lower member 110b. Securing bolts 104a, 104b can have a shoulder that engages with upper member 110a and lower member 110b, respectively, or washers 106a, 106b can be used that engages with upper member 110a and lower member 110b, respectively. In some embodiments, anchor bolt 102 can have a shoulder at one end to engage with one of the members 110a, 110b and the other end can be made to receive another fastener, such as a securing bolt or a rivet, for example.

Upper member 110a and lower member 110b serve as handles and it is important that they are insulated in some manner from the heat generated from pressing heads 120 to protect a user's hands. A modular design can be used where members 110 are comprised of a handle portion 114 and a pressing head portion 115 attached to pressing head 120. This can allow handle portion 114 to be comprised of a material with lower thermal conductivity so that heat from pressing heads 120 is not transmitted to handle portion 114. Handle portion 114 can be tubular to reduce weight and assist with head dissipation. Handle portion 114 should be located at the opposite end of pressing head portion 115 to provide maximum mechanical force at pressing heads 120.

A handle insulator 117 can also be used to limit thermal conductivity between pressing head portion 115 and handle portion 114. Handle insulator 117 can be a ring composed of an insulating material that limits the contact area between handle portion 114 and press head portion 115.

Members 110 can also include a heat dissipater 118 that can further assist with preventing members 110 from becoming too hot. Heat dissipaters 118a, 118b illustrated in FIG. 1 provide a number of apertures in handle portions 114a, 114b to increase the surface area and heat dissipating ability of handle portions 114a, 114b. Other embodiments of heat dissipater 118 can include cavities, fins, pins, or other structures commonly used in heat sink design to improve heat dissipation. Handle portion 114, pressing head portion 115, or both portions, can include one or more heat dissipaters 118. In some embodiments, heat dissipater 118 can be integrally formed with members 110 by simply having a cross-sectional profile that increases surface area.

Some embodiments can include an insulating material that surrounds handle portion 114. For example, handle portion 114 can include a sheath or wrapping made from plastic, rubber, or silicone. Using an insulator surrounding handle portion 114 may be preferable in non-modular embodiments (i.e. upper and lower member 110a, 110b are integrally formed, such that they are each cast or molded as a single part).

Tail portion 116 can include a locking mechanism that is used to apply increased pressure and maintain pressure at pressing heads 120. In the embodiment illustrated in FIG. 1, tail portion 116a of upper member 110a receives pressing bolt 130 allowing the threaded portion of pressing bolt 130 to pass therethrough and the shoulder of pressing bolt 130 engages with tail portion 116a. Pressing bolt 130 threadingly engages threaded aperture in tail portion 116b of lower member 110b. Pressing bolt 130 can have a head to accept a tool, such as an Allen key, or have a wing head to allow pressing bolt 130 to be hand tightened. Other embodiments can include other types of locking mechanisms such as an adjustable clamp, a racheting system, a buckle, a latch, or other type of system that can apply and maintain torque. Locking mechanism is preferably located near the end of upper and lower members 110a, 110b, opposite anchor bolt 102 to apply the most mechanical advantage of the lever to apply the most pressure. Portable heated press 100 can also be used in conjunction with a pneumatic or hydraulic press applying pressure to tail portions 116a, 116b, which will amplify the pressure of the press and can allow weaker or cheaper presses to be used.

It is preferable that the passthrough aperture in tail portion 116a provides enough clearance to allow for upper member 110a and lower member 110b to not be parallel (e.g. when pressing a thicker material at pressing heads 120 or allowing for some flexion of upper and lower members 110a, 110b). The passthrough aperture may be oblong in the longitudinal direction of members 110a, 110b, for example, to provide this improved clearance in some embodiments.

In some embodiments, tail portion 116a, 116b can also be a separate modular part of upper member 110a and lower member 110b, respectively. For example, if handle portion 114 is tubular, it may be preferred to have a solid tail portion to provide strength to the passthrough aperture in tail portion 116a and the threaded aperture in tail portion 116b. Handle portion 114 is illustrated with threaded apertures 132 that can receive screws to attach press head portion 115 and tail portion 116.

In some embodiments, tail portions 116a, 116b can be configured to provide increased clearance, such as having a narrower cross-section, for example, so that they do not make contact with one another in the closed position. This increased clearance can allow greater force to be applied and flexion of upper and lower members 110a, 110b towards one another.

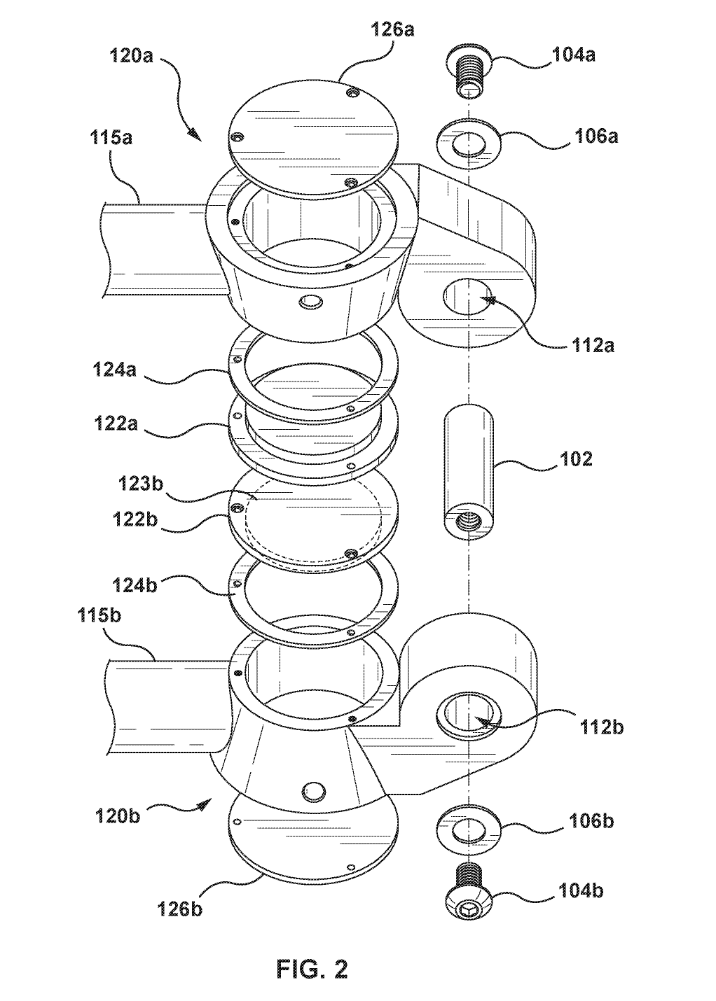

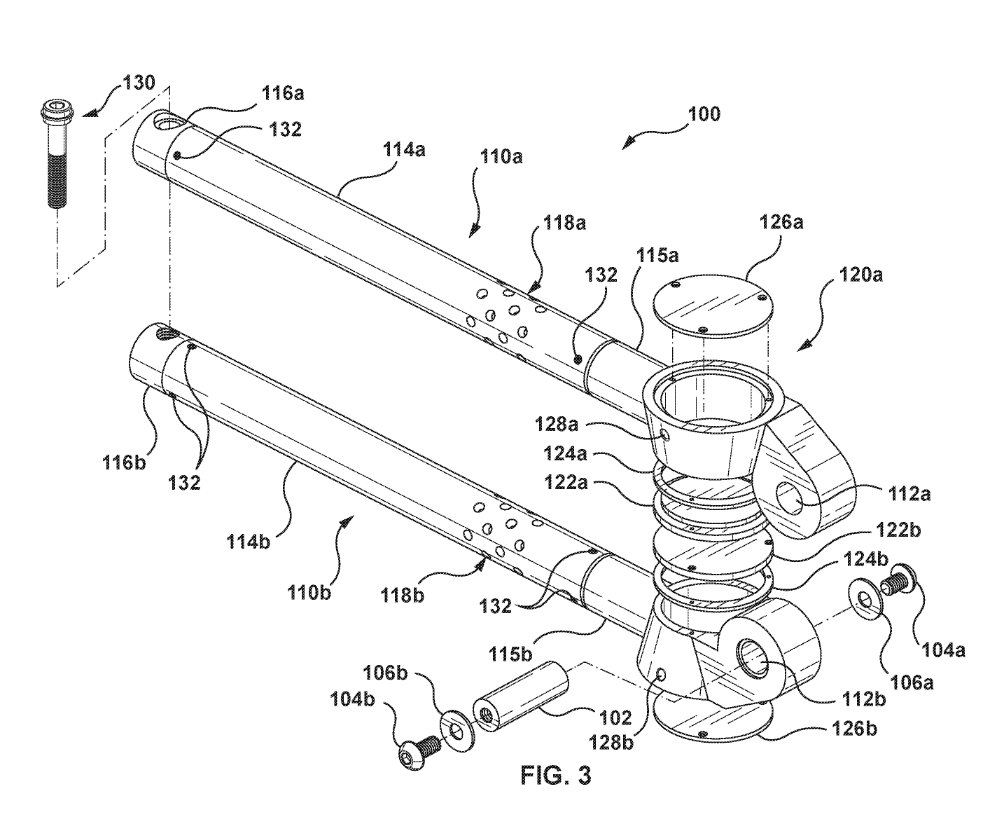

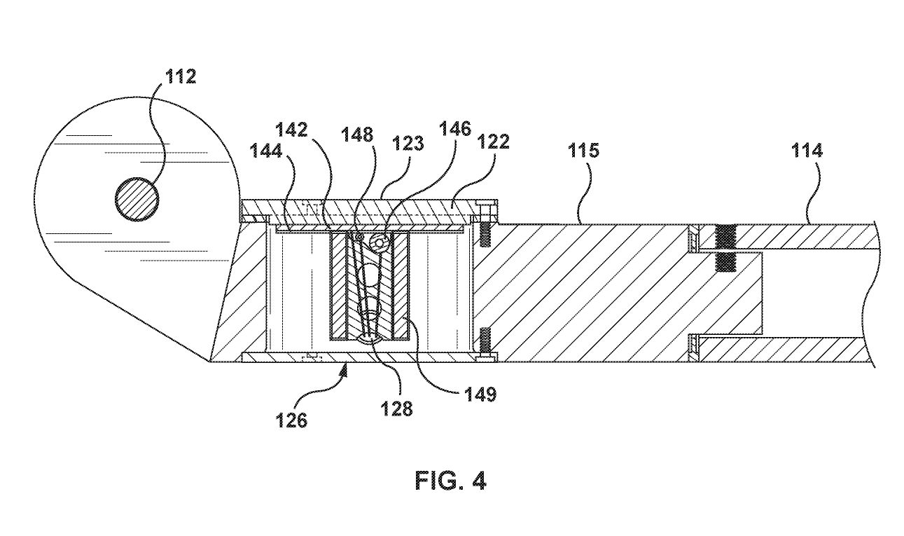

Reference is next made to FIGS. 2 and 3, shown is an exploded view of the mechanical components of pressing heads 120a, 120b. Pressing heads 120 provides a cavity to house the electrical components which are described with respect to FIG. 4. Pressing heads 120a, 120b each have a platen 122a, 122b, respectively. Platen 122a, 122b apply heat and pressure to the material that is being pressing. For this reason, platens 122a, 122b should be comprised of material that is hard and thermally conductive, such as steel or some aluminum alloys.

Platens 122 are preferably round and flat to evenly distribute heat and pressing force, but rectangular or other shapes can be used. Platens 122 are shown with a flat pressing surface 123. Other embodiments can have a pressing surface that incorporates patterns or shapes with varying degrees of protrusion or indentation. For example, pressing surface 123a (not visible) of upper platen 122a can have radial protrusions that extend from a center portion towards the edges of pressing surface 123a, and pressing surface 123b of lower platen 122b can have complementary radial indentations. These indentations and protrusions can help to route the plant concentrate radially away from the plant material being pressed. In other embodiments, platen surfaces 123 can be complimentary with concave and convex surfaces.

Pressing heads 120 can also include an insulator ring 124 that helps to insulate pressing heads 120 of portable heated press 100 from platens 122. Insulator ring 124 is placed between platens 122 and pressing heads 120 to prevent contact of platens with pressing heads 120 and direct heat conduction. Insulator ring 124 should have low thermal conductivity, high heat durability and endurance, and should be mechanically rigid as not to compress from the pressing force applied to pressing heads 120. Some embodiments can use an insulator ring 124 comprised of stainless steel which can withstand mechanical pressure. In other embodiments, insulator ring 124 can by comprised of a high temperature resistant plastic, such as glass fiber reinforced nylon, carbon fiber reinforced nylon, or polyamide-imides thermoplastics such as those sold by Solvay Specialty Polymers under the trademark Torlon. Insulator ring 124 will slow heat transfer from platens 122 to upper and lower members 110a, 110b, which helps keep handle portion 115 cooler to protect users during operation, and insulator ring 124 also makes portable heating press 100 more energy efficient.

Platen 122 and insulator ring 124 can be secured to pressing head 120 by screws that pass therethrough and engage with pressing head 120. In other embodiments, a part of the circumferential surface of platen 122 can be threaded and fastened into pressing head 120 having an internal complimentary threading. This can allow platens 122a, 122b to be easily replace worn-out platens or use a different set of platens with differing thermal or mechanical properties, or having a different pressing surface (e.g. flat or patterned). This provides an improvement over prior art approaches that do not allow the heated surface to be easily replaced as it undergoes deformation over time.

Some embodiments can also include a cap 126 that is secured to the opposite side of pressing head 120 from platens 122. Preferably, cap 126 is removable to allow access to the internal electrical components for maintenance as may be required.

Reference is next made to FIG. 4, shown is a cross-sectional view of a pressing head 120 illustrating a heating element 142 attached to platen 122. Heating element 142 can be an electrical resistive heating device, such as a metal-ceramic heater, for example. In some embodiments, heating element 142 can be sandwiched between platen 122 and a heat spreader 144. Heat spreader 144 can be comprised of a material with good thermal conductivity such as a thin layer of stainless steel, for example.

A temperature sensor 146 can also be used to assist with controlling the temperature of platen 122. Temperature sensor 146 can be any electronic temperature measuring device, such as a thermocouple, for example. A controller can use the feedback from temperature sensor 146 to control heating element 142 in order to provide a precise quantity of heat to platen 122. Temperature sensor 146 can be attached to heat spreader 144 to measure temperature, which should be fairly similar to the temperature at platen 122. In some embodiments, temperature sensor 146 can be embedded into platen 122 to read the temperature of platen 122 directly, and thus removing the need for heat spreader 144.

A thermal safety fuse 148 can be coupled to heating element 142 to prevent overheating or risks of fire (for example, in the case of a faulty temperature sensor 146). If a safety temperature of thermal safety fuse 148 is exceeded, thermal safety fuse 148 will blow and cut-off electrical power to heating element 142.

Internal components to pressing head 120 can be mounted or held in place by containment structure 149, which is composed of a heat resistant material, such as high temperature plastic or nylon. Containment structure 149 can also serve as a wiring guide to assist with routing wires from heating element 142, thermal safety fuse 148, and temperature sensor 146 within pressing head and out through wiring aperture 128. Preferably, wiring is wrapped in a heat resistant tubing to avoid temperature damage.

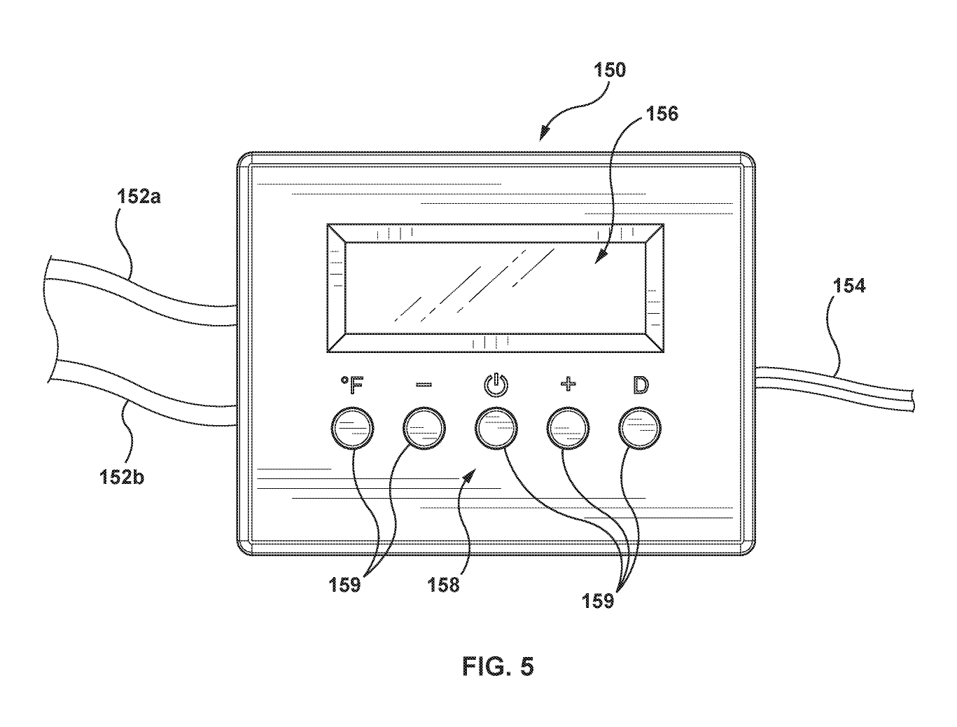

Reference is next made to FIG. 5, shown is a controller housing 150 which provides an interface to control functions of portable press device 100. In some embodiments, controller housing 150 can also be attached to upper or lower member 110a, 110b of portable press device100. Press head wiring 152a, 152b from pressing heads 120a, 120b, respectively, is routed into controller housing 150. Press head wiring 152 can include the aforementioned wiring for heating element 142, thermal safety fuse 148, and temperature sensor 146. Power cable 154 can provide power from a mains electrical outlet, and controller can include a power supply circuit to convert mains electricity for use with other components within controller housing 150. Controller housing 150 can have a display 156, such as liquid crystal display, and a control interface 158, that can consist of a number of buttons 159. In some embodiments, control interface 158 can be provided by an external computing device that is connected to controller by a wireless communications network, such as a short-range wireless standard for personal area networks or a wireless standard for local area networks.

Controller housing 150 has a controller (e.g. microcontroller, system-on-chip, or other programmable computing device) that receives input from temperature sensor 146 that is used to regulate power to heating element 142 in order to provide a desired temperature at platens 122. The controller can be coupled to a memory that stores instructions that when executed operate to control portable heating press 100. Control interface 158 can be coupled to controller to provide a means for some of the following functionality: to turn the device on or off; decrease or increase temperature of platens 122; toggle the units displayed on display 156 between Celsius and Fahrenheit; toggle between using one or both platens 122; or starting or stopping timers. Some embodiments may also include an electronic pressure sensor that controller can use to provide a pressure readout on display 156.

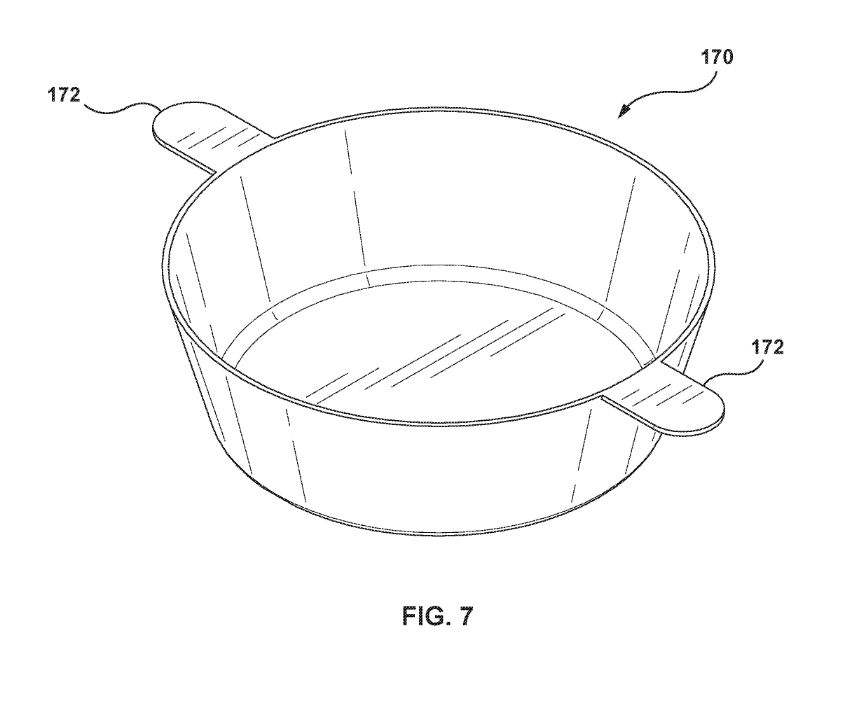

Reference is next made to FIG. 6, shown is portable heating press 100 in a hot plate configuration that allows upper member 110a and lower member 110b to be open at a 180-degree angle and lower member 110b to sit on a flat surface. Preferably, lower member 110b is configured to rest on a flat surface, such as by have a flat surface provided on the bottom of lower pressing head 120b as shown. In the hot plate configuration, one or both platens can be heated based on input to controller from controller interface 158, such as by pressing button 159 labelled “D”. FIG. 7 illustrates a heating pan 170 that can be placed on one of platens 122a, 122b. Preferably, the bottom surface of heating pan 170 has a similar size to platens 122a, 122b. Heating pan handles 172 can be used to hold heating pan 170 and can further include a thermal insulation cover, such as plastic or silicone, to protect a user's hands from burns.

It is desirable to provide portable heating press 100 along with heating pan 170 in a kit to allow consumers to further process the plant concentrates. For example, plant material can be placed between parchment paper, placed between platens 122a, 122b, and extracted at a desired temperature via controller. The controller can include a timer and audible alarm to indicate that extraction is complete. After the extraction of the plant concentrate is complete, the extracted plant concentrate can be removed from the parchment paper and placed into heating pan 170. Portable heating press 100 can then be placed into the hot plate configuration, heating pan 170 containing the extracted plant concentrate is placed on platen 122b, and the controller can be used to heat up platen 122b to the appropriate temperature to further process the extracted plant concentrate into a processed plant concentrate that may be more bioavailable, potent, or have different chemical properties.

While the exemplary embodiments have been described herein, it is to be understood that the invention is not limited to the disclosed embodiments. The invention is intended to cover various modifications and equivalent arrangements included within the spirit and scope of the appended claims, and scope of the claims is to be accorded an interpretation that encompasses all such modifications and equivalent structures and functions.

1. A portable heated press comprising:
an upper member having a first pressing head, the first pressing head having a first electrically heated platen; and
a lower member having a second pressing head, the second pressing head having a second electrically heated platen, the lower member hingedly coupled to the upper member near the first and second pressing heads.

2. The portable heated press of claim 1, wherein upper member and lower member each further comprise an insulator ring attached between the electrically heated platen and the pressing head, the insulator ring having low thermal conductivity and mechanical rigidity.

3. The portable heated press of claim 2, wherein the insulator ring is comprised of any one of: stainless steel, high temperature resistant plastic, a glass fiber reinforced nylon, a carbon fiber reinforced nylon, and a polyamide-imides thermoplastic.

4. The portable heated press of claim 1, the upper member and lower member each have a handle portion opposite respective pressing heads.

5. The portable heated press of claim 4, wherein upper member and lower member each further comprise a handle insulator between the handle portion and the pressing head.

6. The portable heated press of claim 4, wherein upper member and lower member each further comprise a heat dissipater between handle portion and the pressing head.

7. The portable heated press of claim 1, wherein upper member and lower member each further comprise a tail portion having a locking mechanism.

8. The portable heated press of claim 7, wherein the locking mechanism is any one of a pressing bolt, a clamp, a racheting system, a buckle, and a latch.

9. The portable heated press of claim 1 wherein each pressing head has an electrical heating element attached to platen.

10. The portable heated press of claim 9 wherein at least one pressing head has a temperature sensor.

11. The portable heated press of claim 10, further comprising a heat spreader attached between the temperature sensor and the electrical heating element.

12. The portable heated press of claim 10, further comprising a controller coupled to the temperature sensor and each electrical heating element, the controller receiving feedback from the temperature sensor to control the electrical heating element.

13. The portable heated press of claim 12 further comprising a thermal safety fuse.

14. The portable heated press of claim 13, where each pressing head further comprise a containment structure to maintain any one or more of: the electrical heating element, the heat spreader, the temperature sensor, and the safety fuse, positioned within the pressing head.

15. The portable heated press of claim 12, wherein the lower member and upper member can be opened at a 180-degree angle, and the lower member has a flat bottom surface.

16. The portable heated press of claim 15, wherein the controller can be configured to activate second electrically heated platen of the lower member, and to deactivate first electrically heated platen of the upper member.

17. A kit for extracting and processing plant material, the kit comprising:
the portable heated press of claim 16; and
a heating pan sized for the second electrically heated platen.
